(19) United States
(12) Patent Application Publication
(10) Pub. No.: US 2025/0265642 A1
(43) Pub. Date: Aug. 21, 2025

(54) Automated Loan Origination Based on Basket of Goods

(71) Applicant: Windy Hill Pte Ltd, Singapore (SG)

(72) Inventors: Muhammad Daffa Robani, Bandung (ID); Seyed Hossein Ghotbi, Bristol (GB); Dino Setiawan, Singapore (SG); Arief Radityo, Tangerang City (ID); Ying Li, Bellevue, WA (US)

(21) Appl. No.: 18/442,874

(22) Filed: Feb. 15, 2024

(51) Int. Cl. G06Q 40/03; G06Q 20/24; G06Q 20/40

(52) U.S. Cl. CPC G06Q 40/03; G06Q 20/24; G06Q 20/40145

(57) ABSTRACT

A wholesale supplier may extend credit to a merchant based primarily on the merchant's basket of goods being purchased. The supplier may analyze historical purchases to identify purchases of similar baskets of goods, then determine that the current basket of goods represents an appropriate credit risk. Based on the credit risk, the supplier may offer terms of repayment to the merchant where the supplier would otherwise normally demand payment upfront in full. The merchant may accept the loan offer, at which point, various know your customer features may be captured, such as a government identification or biometrics such as image of the merchant's face, and the loan may be originated. The image of the merchant's face may be used on subsequent visits to the wholesale supplier to associate subsequent purchases with the merchant, as well as to extend further credit as appropriate.

### BACKGROUND

Loans between businesses are made in countless circumstances. In general, a borrower may apply for a loan from a lending institution. The lending institution may analyze the borrower's credit history, assets, or other historical or current data to determine the borrower's suitability for a loan.

### SUMMARY

A wholesale supplier may extend credit to a merchant based primarily on the merchant's basket of goods being purchased. The supplier may analyze historical purchases to identify purchases of similar baskets of goods, then determine that the current basket of goods represents an appropriate credit risk. Based on the credit risk, the supplier may offer terms of repayment to the merchant where the supplier would otherwise normally demand payment upfront in full. The merchant may accept the loan offer, at which point, various know your customer features may be captured, such as a government identification or biometrics such as image of the merchant's face, and the loan may be originated. The image of the merchant's face may be used on subsequent visits to the wholesale supplier to associate subsequent purchases with the merchant, as well as to extend further credit as appropriate.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a schematic illustration of an embodiment showing an underwriting system using purchase history and basket composition.

FIG. 2 is a diagram illustration of an embodiment showing a network environment with an underwriting system.

FIG. 3 is a flowchart illustration of an embodiment showing a method for analyzing transactions for creditworthiness.

FIG. 4 is a flowchart illustration of an embodiment showing a method for analyzing merchant history for creditworthiness.

FIG. 5 is a flowchart illustration of an embodiment showing a method for offering loans based on basket contents.

FIG. 6 is a flowchart illustration of an embodiment showing a method for using facial recognition to offer loans.

### DETAILED DESCRIPTION

### Credit and Loan Origination for Wholesale Supplier/Retail Merchant Relationships

Merchants, as defined herein, are retail businesses that purchase from wholesale suppliers. A merchant may, for example, sell at a corner store, and the merchant may purchase their goods from a wholesaler, known herein as a supplier.

In many cases, a supplier may maintain accounts receivables for some merchants, but other merchants may buy their baskets of goods using cash. For suppliers without computerized or highly automated point of sale systems, many of their transactions may be attributed to “cash” accounts, even though the suppliers may have longstanding personal relationships with the merchants.

A loan origination system may analyze purchases categorized in the “cash” accounts to determine whether a basket of goods being purchased may qualify for a loan. Such a system may be counter-intuitive, as some or all of the purchases in the “cash” accounts may be purchased by completely different, unrelated merchants. However, because the basket of goods being purchased may be similar to other previous purchases, the loan origination system may determine that the merchant may be creditworthy, even when the merchant has little documented history of past purchases.

The loan origination system may analyze a current basket of goods being purchased by a merchant. The current basket of goods may be entered using a point of sale (POS) system that may, for example, scan barcodes or otherwise enter each of the items being purchased.

The current basket of goods may be compared to historical transactions in a transaction database to identify a group of similar transactions. From the similar transactions, an assessment may be made of the creditworthiness of the transaction, and by extension, the creditworthiness of the merchant.

A simplified explanation of the theory may be that similar historical transactions may indicate that those merchants are consistently able to sell that particular basket of goods. Therefore, any merchant that purchases a similar basket of goods would be a good credit risk and eligible for a loan.

The basket of goods may be a mixture of items purchased at wholesale for reselling in a retail venue. A successful retailer may purchase similar items again and again to service their customer base. Those items may reflect various characteristics of the neighborhood in which the retailer merchant operates, including the customer's tastes and preferences, their income level, their affinity for specific brands or items, and other factors. When a merchant successfully purchases items over and over, that merchant appears to be operating a healthy, reliable, and well-functioning retail business.

When evaluating a basket of goods to find similar baskets of goods, many factors may be evaluated. For example, aggregate or meta variables such as the total number of items, the total value of the basket, or other factors may give clues to similarity. Various item-by-item analyses may evaluate the quantity of specific items, the diversity or similarity of one item to other items in the basket, the relationships between items, the retail size of packaging of the items, brand names of the items, generic names of the items, or any other factor. In some cases, information about the purchases may be used, such as time of day of purchases, day of week, day of month, seasonality of the purchases, or other factors may indicate similarity.

Some systems may assign specific merchants to the baskets of goods that they purchase. Some point of sale systems, for example, may track a merchant's name, phone number, address, or other identifying information with each purchase. In contrast, some sales may be merely labeled ‘cash’ sales because such identifying information may not be collected. For sales that are made using a cash transaction, no identifying information may be collected.

When baskets of goods are assigned to a merchant and tracked over time, a supplier may have an accurate record of the merchant's sequence of baskets purchased. Such a sequence of baskets may indicate the merchant's business health, as the re-purchase of an item may indicate that the merchant successfully sold that item since the last visit to the supplier. In another theory, the re-purchase of an item may indicate that the merchant may have the business confidence that the item will sell.

By using the basket of goods as a primary factor for determining the suitability for a loan, a loan underwriting process may correlate similar previous purchases as sufficient indicators for creditworthiness, even if some or all of those similar baskets may have been purchased by a different merchant. Such an underwriting technique may go against many longstanding underwriting techniques, where data used for underwriting would be associated with the borrower.

For example, a conventional underwriting process may request financial statements, purchase and sales history, or other information relating to a merchant's business. Further, some underwriters may ask for personal guarantees, property records, banking records, or other data that may be directly or indirectly associated with the merchant or the merchant's business.

Underwriting using the basket of goods may appear at first glance to be a higher risk than underwriting using conventional techniques. However, a supplier may have an extensive history of basket purchases that may indicate that those baskets of goods are in line with many previous purchases, even if those purchases were not associated with individual merchants. Nonetheless, a merchant who purchases a similar basket may be considered a low credit risk because other merchants have made similar and repeated purchases in the past.

In other words, the purchase of a basket similar to other historical baskets may indicate that the merchant making the purchase has a business that may be similar to the other merchants who buy similar baskets. Since there may be a history of repeated purchases, the basket of goods may be reliably sold by the merchants. As such, even if a new merchant were to buy a basket of goods where that basket of goods was historically shown to sell reliably, that new merchant may be offered a loan.

The insight of the underwriting is that certain baskets of goods have been shown to be good selling products for a set of merchants. Any merchant who buys a similar basket of goods would then, by inference, have a high likelihood of being able to successfully sell a similar basket of goods at their retail store. Such an underwriting metric may focus on the sales performance of the basket selected by the merchant over and above other factors commonly used for underwriting.

In one way of thinking about the underwriting, by focusing on the basket of goods, the past performance of that basket of goods may be given more credence than the past performance of that merchant. As such, credit may be extended to the merchant based on their basket rather than their credit history, assets, or other factors.

Throughout this specification and claims, the term “merchant” may represent a business that may be reviewed for creditworthiness, fraud, or other uses. In the language of this specification, a “supplier” may be a wholesaler to the “merchant,” whereby the “supplier” sells goods, supplies, or services to the “merchant,” who may manufacture or resell various products. The term “merchant” may be the subject business that is being analyzed. The “merchant” is a “buyer” in the relationship, and the “supplier” is the “seller.”

The ‘basket’ refers to the group of goods purchased by the merchant from a particular supplier. Several factors may be derived from the basket, such as the concentration of individual products, the product entropy or diversity, the total amount purchased, and other factors. These factors, when compared against other merchants and previous purchases, may be a very strong indicator of creditworthiness.

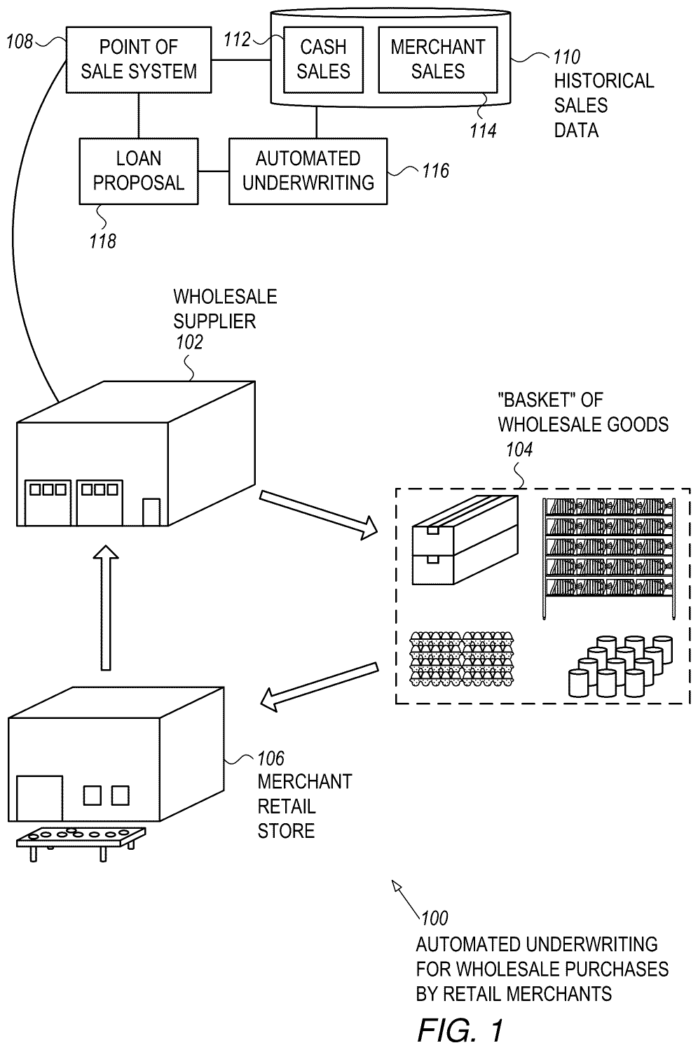

FIG. 1 is a diagram illustration of an embodiment 100 showing an automated underwriting system for wholesale purchases. A wholesale supplier 102 may sell a basket of goods 104 to a merchant 106, who sells the goods at retail. As the items are sold, the merchant 106 goes back to the wholesale supplier 102 to purchase more inventory.

The cycle of sales in the illustration may represent any type of wholesale or commercial transaction that is repeated. Although the illustration shows a merchant who resells goods at retail, the same principles may be applied to smaller manufacturers who may purchase wholesale goods from a supplier 102, add value to the wholesale goods, then sell to retailers or to other distributors or even other manufacturers.

The basket of goods 104 may be a mix of different goods and different quantities of goods. In many situations, small manufacturers or retailers may purchase similar baskets of goods over time. The baskets may not be exactly the same each time, but may have similar characteristics. In the retail trade, small shops may generally sell the same type of items and in similar quantities or ratios between the items.

In a simple example, a corner retail store may sell eggs, milk, bread, and assorted canned goods. That retail merchant may sell roughly the same ratio of eggs to bread, although the quantities and ratios may vary depending on the season, the weather, holidays, or other factors. In many cases, retail merchants may have yearly seasonal variations, as well as other variations during the year.

A point of sale system 108 may collect and document each transaction between the supplier 102 and the merchant 106. A point of sale system may have, for example, a barcode scanner that may log each item and quantity. The point of sale system may calculate a total cost of the purchase, collect payments, and settle accounts.

A database of historical sales data 110 may include cash sales 112 and merchant sales 114. Merchant sales 114 may be sales that may be associated with specific merchants, as opposed to cash sales 112, which may not be associated with a specific merchant.

Many wholesale suppliers set up accounts for specific merchants. This may allow the supplier to track the merchant's sales over time, as well as to extend terms to specific merchants, such as payment in 15 or 30 days. Some suppliers may offer discounts, promotions, or other benefits for having a merchant account.

Cash sales may be any sale where no merchant may be associated. In some industries, such as purchases by small retailers, each wholesale purchase may be settled at the time of purchase, often with cash. Such sales may not associate the sale to a specific merchant, and as such, the amount of cash sales 112 may be a large percentage of a wholesale supplier's historical sales data 110.

An automated underwriting system 116 may analyze the historical sales data 110 to determine whether or not the purchase being made may qualify for a loan. When a loan may be appropriate, a loan proposal 118 may be offered to the merchant at the time of sale. The point of sale system 108 may present the loan offer to the merchant, and if accepted, the merchant may set up an account, enter various know-your-customer features, and the loan may be consummated.

The automated underwriting system 116 may analyze past transactions, including transactions associated with a merchant and cash transactions to determine whether the purchase may qualify for a loan. In some cases, the merchant making a purchase may be a long time customer of the supplier and may be well-known personally to the supplier's staff for repeated purchases. In other cases, the merchant may be a first-time customer.

The characteristics of a merchant's basket of goods 104 may be an excellent indicator of creditworthiness, even if the merchant has no previous connection or association with a supplier.

The overall size or value of a basket of goods may vary from basket to basket, but a merchant may purchase similar baskets over a long period of time. Such merchants may be a good credit risk simply because similar baskets over time may demonstrate that the merchant may be consistently able to sell those products.

Many industries, including small retail merchants, may have similar buying behavior across merchants. The merchants may not specifically compete with each other, but may operate similar businesses. For example, merchants that operate corner stores in local neighborhoods may sell similar items, even though the merchants may be located at different locations across a city. Hence, the baskets of goods purchased by different merchants may be remarkably similar to each other.

Similar baskets of wholesale goods that may be purchased repeatedly may indicate that those goods are very likely to be sold by a specific merchant, but may also indicate that those goods are likely to be sold by any merchant or a typical or generic merchant. This insight allows an automated underwriting system 116 to determine creditworthiness based purely or primarily on the contents of the wholesale basket of goods 104.

Once a loan may be offered and accepted, a merchant may then create an account, which will add their current and future sales to the merchant sales 114 data. From that point forward, the automated underwriting system 116 may use the merchant's known sales as a factor for underwriting future loans.

In many cases, an automated underwriting system 116 may use a machine learning model. The machine learning model may be trained to identify baskets of goods that may indicate good creditworthiness. Such models may use historical data of identified merchants that may have purchased similar baskets of goods on a consistent basis, as well as merchants that may have purchased similar baskets of goods on credit and have successfully repaid any loans. The machine learning model may also be trained to identify fraudulent behavior in addition to creditworthiness. Such a machine learning model may determine when a fraud may have occurred, which may be used to quickly identify and track down problems prior to the problems escalating.

The machine learning model may generate a confidence score indicative of creditworthiness. Using existing data from several suppliers' databases, several machine learning models have been developed and tested using just the basket of goods as a determining factor of creditworthiness with meaningful, reliable, and consistent confidence scores for credit applicants. The model may be created using a training set of previous loans that were successfully repaid, along with repeated purchases of baskets of goods where no merchant may be associated. Successful and reliable models have been created using purely “cash” purchases of sequences of baskets of goods without associating specific merchants to those purchases.

### Improvement to Computer Systems

The automated underwriting system 116 fundamentally changes the function, performance, and usefulness of a conventional computer system. When the machine learning system operates on a conventional computer, that computer may be transformed into a device that underwrites loans much faster than conventional underwriting and with a much higher accuracy.

In some cases, portions of the machine learning system may be performed on specialized computer systems. Such systems may have specialized circuitry adapted for machine learning applications, such as hardware for running models of multi-level neural networks for example. Other systems may be specialized for training such neural network models.

Even when the machine learning system operates on a conventional computer system, that conventional computer system is given capabilities that have never been present in a conventional computer system. Such capabilities include the ability to approve or deny loans automatically or with human oversight, and the capability of analyzing a history of baskets of goods uncorrelated to a purchasing merchant to determine creditworthiness.

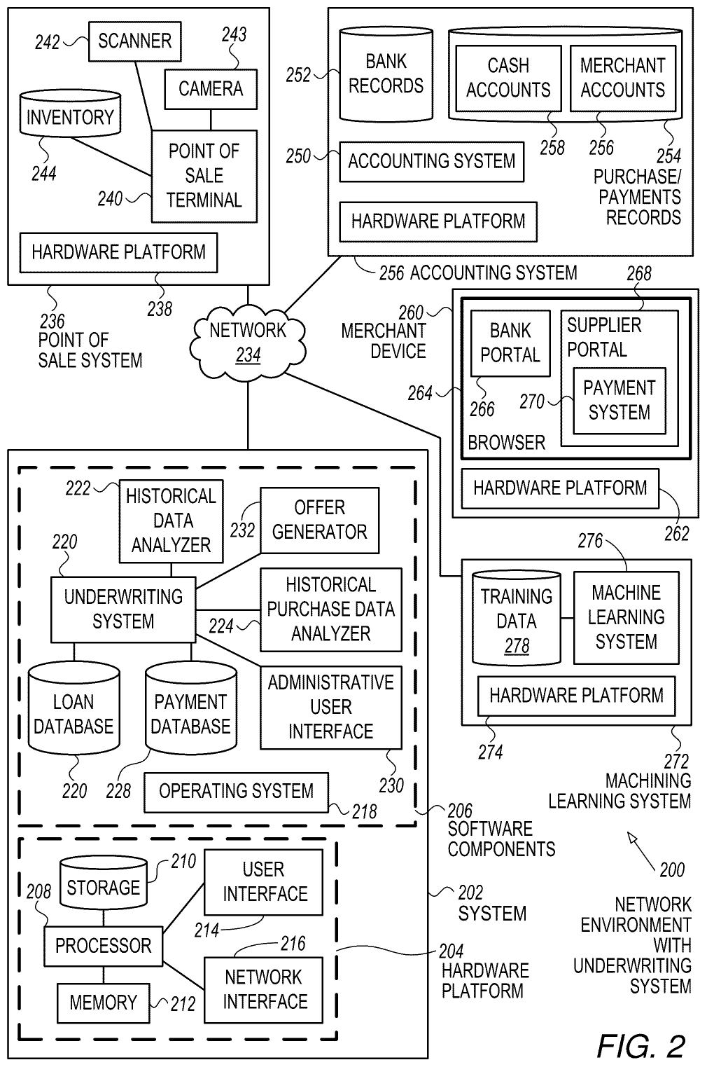

FIG. 2 is a diagram of an embodiment 200 showing components that may perform underwriting for loans using a basket of goods as the sole or primary factor for determining creditworthiness.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An underwriting system 220 may determine whether a merchant may be creditworthy and suitable for a loan. The underwriting system 220 may use several different data sources to determine suitability, but the primary, and sometimes only source may be historical purchases by merchants.

A current basket of goods may be compared to other baskets of goods previously purchased. When the previous purchases were made by the merchant making the purchase, a history of purchases may be analyzed. However, current purchaser may not have a documented track record of purchases, but the contents of the basket may be similar to other purchases. The other purchases may have been made by the purchaser but not documented as such, such as when the purchaser made similar purchases using cash. Or the other purchases may have been made by other merchants who purchase similar baskets of goods.

The contents of the basket of goods may indicate whether that basket may be favorable for underwriting. A basket of goods that may have been purchased repeatedly in the past may indicate that the buyer, a merchant, may successfully process those goods as a manufacturer, or may sell those goods as a retailer. When a basket has been purchased over and over, that basket may indicate a high likelihood of commercial success for the next purchase of a similar basket.

The baskets may be compared by calculating different variables that indicate similarity. Various factors of the basket contents may be calculated, such as the quantity of items. The items may be classified by the specific Stock Keeping Unit (SKU), which may include the specific size, packaging, manufacturer, or branding of the item. Classification may be by the generic name of the item without size, packaging, or branding of the item. The quantity and packaging of the items may be a factor in similarity.

The baskets may be compared by the mixture of different items, as well as the ratio or amount of one item to another. A merchant that sells fresh goods in a neighborhood store may consistently purchase the same basic ratio of eggs, milk, and bread, for example, even though one basket may be larger than another over different seasons.

A historical data analyzer 222 may analyze previous basket purchases to identify the characteristics of baskets that have been purchased in the past. The history of previous basket purchases may identify those baskets that may represent those merchants who operate successful businesses. An assumption that a successful business will consistently and repeatedly purchase and subsequently sell similar baskets, and as such, the baskets may indicate creditworthiness.

A historical purchase analyzer 224 may identify merchants who have purchased baskets on credit and the characteristics of those baskets where the credit was successfully repaid. In general, baskets that may be successfully repaid and those that may be purchased over and over may reflect those baskets with the lowest credit risk. The historical purchase analyzer 224 may reference a loan database 226 and payment database 228 to identify those baskets that have been successfully repaid.

The underwriting system 220 may have an administrative user interface 230. The administrative user interface 230 may allow a supplier or their accountants to set up a loan processing system, check the status of existing and completed loans, adjust the algorithm for determining creditworthiness, and other administrative functions.

An offer generator 232 may create a loan offer for a merchant. The loan offer may include payment terms, interest rate, and other factors of a loan. The loan offer may be automatically generated, although some systems may involve a human reviewer or underwriter who may review and approve or deny a loan offer.

A network 234 may connect various devices illustrated.

A point of sale system 236 may operate on a hardware platform 238 and may have a point of sale terminal 240. The point of sale terminal 240 may be an interface through which a supplier or merchant may enter items for a basket of goods. Many such systems may have a barcode or other scanner 242 which may identify the items and their quantity, and may deduct the items from an inventory database 244.

A point of sale terminal 240 may be an interface through which a loan offer may be made and through which the loan may be accepted and initiated. Other systems may have other interfaces or devices for accomplishing similar steps.

When a loan may be offered and accepted, various know-your-customer (KYC) information may be collected. Various jurisdictions have different requirements for KYC data, such as collecting a government-issued identification number, capturing images of a government-issued identification card or passport, and capturing an image of a merchant and their face, or other biometrics.

In some systems, a video camera may be used to identify merchants that enter a supplier's premises to purchase a basket of goods. Such systems may identify the merchant and associate their purchases, even when the merchant makes a purchase using a cash accounts.

Some systems may identify the merchant as they enter a supplier's warehouse using video or still imagery and comparing the image to a stored image associated with a loan. When a borrower may be identified in the supplier's warehouse and begins the checkout process, a point of sale system 236 may recall the status of any existing loans, such as delinquencies or current payments, and may offer additional loans or request overdue payments.

An accounting system 246 may include a hardware platform 248 on which an accounting system 250 may operate. The accounting system 250 may track the financial accounts of a supplier, such as bank records 252 and various purchase and payment records 254. The purchase and payment records 254 may include purchases and payments in merchant accounts 256 and cash accounts 258. The merchant accounts 256 may include purchases and payments associated with specific merchants. The cash accounts 258 may include purchases and payments that may not be associated with specific merchants. Such purchases and payments may be lumped together with payments and purchases from multiple merchants.

A merchant device 260 may be a device operated by a merchant to connect to and communicate with a supplier's system. The merchant device 260 may operate on a hardware platform 262 and, for this example, may operate a browser 264. The browser 264 may provide an interface to the merchant's bank accounts through a bank portal 266, as well as a supplier portal 268. The supplier portal 268 may be the interface where the merchant may make future purchases, find invoices and records relating to previous purchases, and administer any loans. In many cases, the supplier portal 268 may include a payment system 270 where the merchant may make payments associated with loans, previous purchases, or future purchases.

A machine learning system 272 may be a system that may use historical data to determine whether a loan may be appropriate in various situations. The machine learning system 272 may operate on a hardware platform 274 as a software machine learning system 276. The machine learning system 276 may use various training data 278 to develop an algorithm, such as a neural network, that may receive various input parameters and may output various calculated values. Such calculated values may include a similarity score for a current basket being purchased with other previously-purchased baskets. Another calculated value may include a confidence score, which may be used as a creditworthiness score.

The machine learning system 272 may generate algorithms or neural networks that may be used by the underwriting system 220 for analyzing historical data, as well as analyzing current baskets as potential candidates for loans.

An underwriting system 220 may receive information about a potential loan and process the information to determine a confidence score. A confidence score may be a numerical value that may represent the confidence that the borrower would repay the loan. In some systems, the underwriting system 220 may receive a loan application and may determine the maximum amount of a loan based on a target confidence score.

The underwriting system 220 may include various algorithms. In many cases, calculations involving a potential loan's confidence score may be an artificial neural network algorithm. Such an algorithm may be trained on data that may be curated prior to launch, as well as performance data from loans originated by the underwriting system 220.

In many cases, the underwriting system 220 may have additional algorithms, such as screening rules or other logic that prepares loan data for analysis. Screening rules may be an algorithm that may remove loan applications that do not meet specific criteria. Such rules may have hard parameters that new loans must meet. An example of one such rule may analyze the location of a borrower to ensure that the borrower is in a location where the lender has regulatory authority to issue loans.

Other algorithms may pre-process loan parameters, calculate summary statistics, perform third-party verification of data received from the borrower, or other preparation prior to executing the neural network analysis.

A neural network analysis may, in essence, compare a loan application against all loans in the training set. In a simplified explanation, the comparison may generate a similarity score to those loans considered ‘good’ or desirable. Such a score may be the confidence score that the loan will be repaid in the future.

The underwriting system 220 may operate in a fully automatic mode, where loan applications may be processed very quickly and loan documents prepared and sent to a lender. In such a manner, the underwriting system 220 may operate without human intervention.

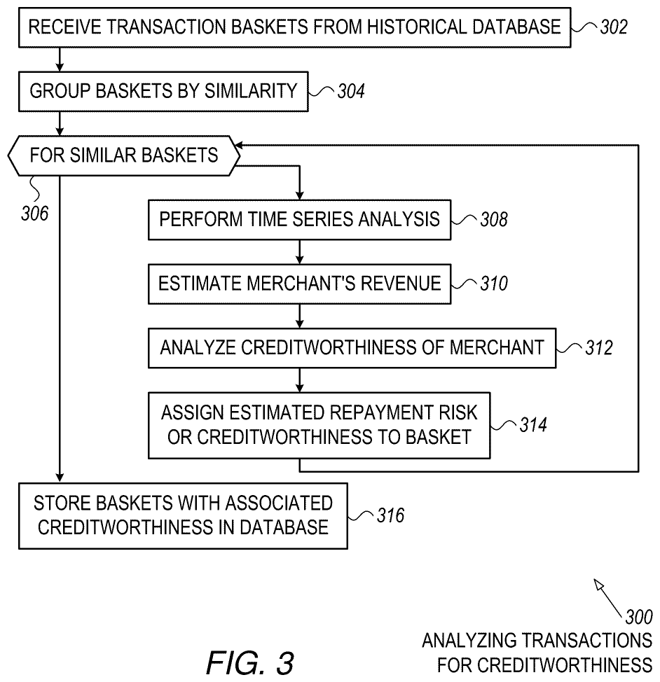

FIG. 3 is a flowchart illustration of an embodiment 300 showing a method of analyzing transactions for creditworthiness. Embodiment 300 shows a process whereby similar baskets may be aggregated to estimate creditworthiness. The aggregated baskets may be scored to identify those baskets that may have high or low creditworthiness. The results of embodiment 300 may be used by subsequent processes to analyze a basket of goods in real time or near real time to determine whether the basket of goods indicates whether the purchaser may be creditworthy.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

A historical database may be queried in block 302 to receive baskets that have been transacted in the past. The baskets may be grouped by similarity in block 304. The similarity factors may be any observable data, such as the Stock Keeping Units and quantity of all the items in a basket or the total cost of the basket, as well as metadata about the transactions, such as time of day, day of week, and data about the merchant who purchased the baskets. The merchant data may include their retail location, prior purchases, or any other factor.

For groups of similar baskets in block 306, a time series analysis may be performed in block 308. The time series analysis may identify factors of seasonality, periodicity, growth, decline, variability, randomness, or other factors for the baskets.

A merchant's revenue may be estimated in block 310 based on the baskets purchased. In general, larger and more frequent baskets may indicate that a merchant has a higher revenue turnover. In a simple example, a merchant who purchases a large number of perishable items, such as bread or fresh produce may indicate a calculatable revenue estimate, as those items have a limited shelf life.

In block 312, the creditworthiness of a merchant who purchased the baskets may be estimated. In cases where a specific merchant may be associated with the basket purchased or where a merchant makes a purchase using a loan or credit, those subsequent transactions may give insight into whether the merchant successfully sold the items in the basket or not. A merchant's ability to repay a loan given their basket history may indicate that the baskets may indicate creditworthiness.

A repayment risk or creditworthiness risk may be assigned to the group of similar baskets in block 314. After processing each group of baskets in block 306, the baskets may be stored with an associated creditworthiness score in a database in block 316.

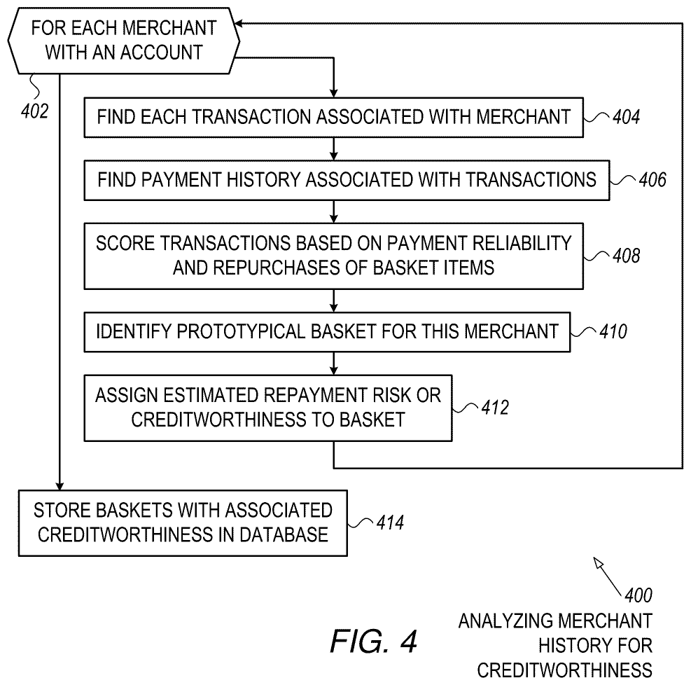

FIG. 4 is a flowchart illustration of an embodiment 400 showing a method for analyzing a specific merchant's purchase history to identify baskets that may be creditworthy. The method takes baskets purchased over time by a specific merchant, then determines whether that merchant may have been successful in selling the baskets, which can be indicated by re-purchases of similar baskets. Using specific merchant's recurring basket purchases, the baskets themselves may be identified as factors for determining creditworthiness.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

For each merchant with an account at a supplier in block 402, the transactions associated with the merchant may be retrieved in block 404. The payment history may also be retrieved in block 406.

The transactions may be scored in block 408 based on payment reliability and repurchases of specific items in the baskets. Items that may be consistently repurchased may indicate that those items may be good sellers and therefore would indicate lower risk of defaulting on a loan. Items that may have been sold once but not repurchased may indicate that those items may not be good sellers and may indicate a higher risk of default.

A prototypical basket for the merchant may be identified in block 410. The prototypical basket may be later used as a comparison against baskets being purchased to determine similarity using the creditworthiness or repayment risk determined in block 412. After analyzing each merchant in the system, a database may be populated with baskets and their associated creditworthiness. In some systems, such a database may be used as training data for a machine learning system, which may generate an algorithm, such as a neural network algorithm, that may calculate creditworthiness using a basket of goods as an input.

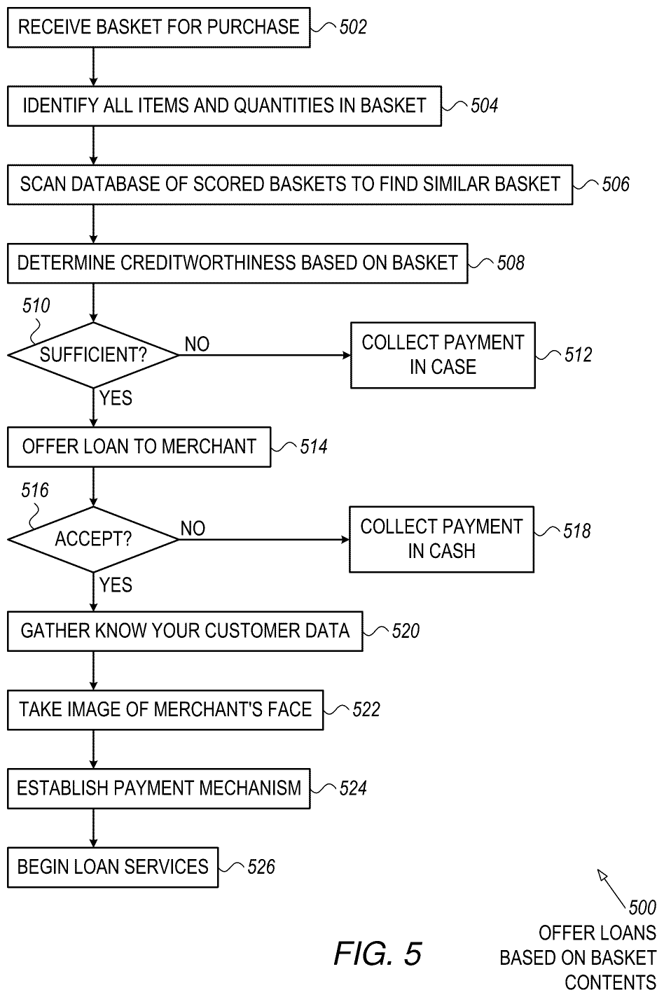

FIG. 5 is a flowchart illustration of an embodiment 500 showing a method offering loans based on basket contents. The process may analyze a merchant's basket at a point of sale system, then determine whether that basket indicates good creditworthiness. If there is good creditworthiness, an offer may be made to finance that purchase and sometimes additional purchases. If the offer is accepted by the merchant, a loan is put in place.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A basket of goods may be received to purchase in block 502. In a typical use case, the basket may be created while a merchant checks out from a trip to the supplier. A point of sale system may scan the items and quantities of goods for the basket, which may be received in block 504.

A database of similar baskets may be scanned in block 506 to identify similar baskets. The creditworthiness of a merchant may be inferred by the basket selection in block 508. If the creditworthiness is not sufficient for a loan in block 510, payment for the basket may be made in cash in block 512.

If the creditworthiness is sufficient for a loan in block 510, a loan may be offered to the merchant in block 514. In many cases, the point of sale system may be the interface through which the loan may be offered. If the loan is not accepted in block 514, payment may be made in cash in block 518.

If the loan is accepted in block 516, various know your customer data may be collected in block 520 along with a camera image of the merchant's face in block 522. A payment mechanism for the merchant to pay the loan may be established in block 524 and the loan may be serviced in block 526.

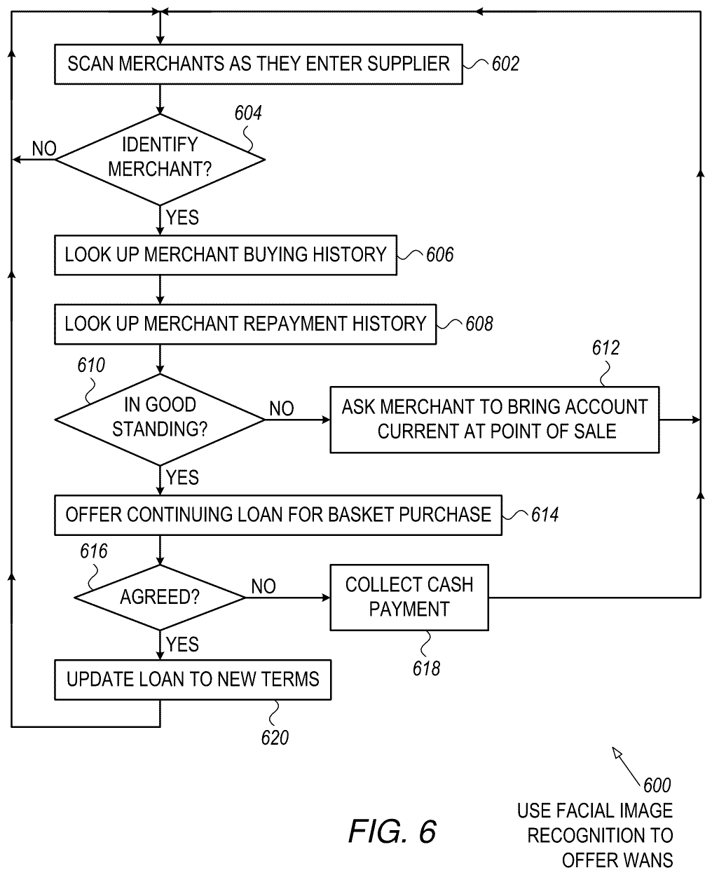

FIG. 6 is a flowchart illustration of an embodiment 600 showing a method for analyzing images of merchants as they enter a supplier's warehouse for a purchase. The images may be used to identify merchants so that their loans may be serviced or extended with their current purchases.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Merchants may be scanned as they enter a supplier's place of business in block 602. If the merchant is not identified in block 604, the process reverts back to block 602.

If the merchant is identified in block 604, the identification may be made by comparing a video or camera image of a merchant taken when they originate a loan to a video feed captured in block 602. The merchant's buying history may be retrieved in block 606, as well as their payment history in block 608.

If the merchant is not in good standing in block 610, the merchant may be asked to bring their account current in block 612 at the point of sale.

If the merchant is in good standing in block 610, an offer for a continuing or new loan for the current basket may be offered in block 614. If the merchant does not agree in block 616, the merchant may pay in cash in block 618. If the merchant does agree in block 616, the loan may be updated with new terms, which may include financing for the current basket.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
electronic access to a seller database comprising historical sales data from a first seller to a plurality of buyers, said historical sales data comprising sales of baskets of goods sold;
at least one processor, said at least one processor configured to perform a method comprising:
receiving a first basket of goods for purchase from a first buyer;
analyzing said historical sales data to identify a group of sales of baskets similar to said first basket of goods;
determining a first confidence score for purchasers of said group of sales;
determining that said first confidence score is higher than a predetermined threshold and offering a loan to said first buyer for at least a portion of said first basket of goods;
receiving acceptance of said loan from said first buyer;
capturing at least one know your customer feature from said first buyer; and
establishing a loan with said first buyer based on at least said first confidence score, said acceptance, and said at least one know your customer feature.

2. The system of claim 1, said group of sales comprising cash sales having no specific buyer assigned to said cash sales.

3. The system of claim 2, said cash sales comprising cash sales from at least said first buyer and a second buyer.

4. The system of claim 3, said second buyer having a cash sale with a second basket of goods similar to said first basket of goods.

5. The system of claim 1, said historical sales data comprising no sales to said first buyer.

6. The system of claim 2, said group of sales comprising a sequence of cash sales of similar baskets.

7. The system of claim 6, said similar baskets being similar in terms of at least one of the group of features composed of:
basket composition;
frequency of purchase;
time of day of purchase; and
seasonality of purchase.

8. The system of claim 2, said know your customer feature comprising a facial image of said first buyer.

9. The system of claim 8, said method further comprising:
storing said facial image of said first buyer in a database.

10. The system of claim 9, said method further comprising:
receiving a video image of said first buyer at said seller, said first buyer;
comparing said video mage to said facial image to identify said first buyer;
determining an association between a second basket of goods and said first buyer; and
storing said association in said seller database.

11. The system of claim 10, said second loan being offered to said first buyer at a point of sale.

12. The system of claim 8, said know your customer feature further comprising an image of a government issued identification.

13. A method performed by a computer processor, said method comprising:
identifying a first basket of goods to be purchased by a first buyer from a seller;
analyzing a historical database of baskets of goods sold by said seller to identify a group of sales of baskets similar to said basket of goods;
determining that said first basket of goods represents a low credit risk;
presenting a loan offer to said first buyer based on said low credit risk, said loan offer being for a first loan being at least large enough to include purchase of at least a portion of said first basket of goods;
receiving acceptance of said loan offer from said first buyer;
capturing at least one know your customer feature from said first buyer; and
establishing a loan with said first buyer based on said acceptance.

14. The method of claim 13, said historical database of baskets of goods sold comprising cash sales of said seller.

15. The method of claim 14, said cash sales comprising at least one sale of a first similar basket being sold to a second buyer.

16. The method of claim 15, said cash sales comprising no sales to said first buyer.

17. The method of claim 14, said cash sales being sales of baskets of goods being sold without an association between the baskets of goods being sold and any specific buyer.

18. A system comprising:
a point of sale system configured to capture sales from a seller to a buyer;
a database configured to store said sales as historical sales;
an analysis engine configured to receive a first basket of goods to be purchased from said seller, said analysis engine further configured to:
analyze said historical sales to identify a group of sales of baskets similar to said first basket of goods;
determine a confidence score for purchasers of said group of sales;
determine that said confidence score is acceptable for a loan; and
flag said first basket of goods for said loan;
said point of sale system further configured to:
receive said first basket of goods for sale to said first buyer;
offering said loan to said first buyer;
receiving acceptance of said loan from said first buyer;
capturing at least one know your customer feature from said first buyer; and
establishing a loan with said first buyer.

19. The system of claim 18, said analysis engine being capable of determining said confidence score without using any identifying information from said first buyer.

20. The system of claim 19, said historical sales comprising cash sales of said baskets, said cash sales being transactions having no specific buyer identified as a purchaser.
